(19) United States
(12) Patent Application Publication
(10) Pub. No.: US 2007/0118649 A1
(43) Pub. Date: May 24, 2007

(54) Methods, apparatuses and computer programs for protecting networks against attacks that use forged messages

(75) Inventors: Daniel J. Sills, Palo Alto, CA (US); Daniel B. Grossman, Norwood, MA (US)

Correspondence Address: GENERAL INSTRUMENT CORPORATION DBA THE CONNECTED;HOME SOLUTIONS BUSINESS OF MOTOROLA, INC., 101 TOURNAMENT DRIVE, HORSHAM, PA, 19044, US

(73) Assignee: General Instrument Corporation

(21) Appl. No.: 11/404,933

(22) Filed: Apr. 14, 2006

Related U.S. Application Data
(60) Provisional application No. 60/738,149, filed on Nov. 18, 2005.

(51) Int. Cl. G06F 15/173

(52) U.S. Cl. 709/225

(57) ABSTRACT

Methods, apparatuses and computer programs for protecting a network against forged messages, or impersonation attacks, which do not require the use cryptography. One or more nodes on the network are configured to detect a forged message and to output an indication that a forged message has been detected. Nodes that receive an indication that a forged message has been detected may then take certain actions, such as, for example, discontinuing use of the protocol associated with the forged message for a period of time.

### CROSS-REFERENCE TO RELATED APPLICATIONS

This application claims priority to a provisional patent application having Ser. No. 60/738,149, entitled “Simple Algorithm To Protect A Network Against Forged Messages”, which was filed on Nov. 18, 2005, and which is hereby incorporated herein by reference in its entirety.

### TECHNICAL FIELD OF THE INVENTION

The invention relates to network communications. More particularly, the invention relates to protecting networks against attacks that use forged messages, or impersonation attacks.

### BACKGROUND OF THE INVENTION

In a communications network, an attacker can attempt to forge a message belonging to any protocol being used by the nodes on the network. Successfully forged messages may be used by the attacker to achieve a variety of objectives, such as denial-of-service and diversion of traffic. Cryptographic authentication mechanisms are well known, and offer very strong protection against forged messages. However, cryptography is computationally complex and can be administratively difficult to deploy, which means that in many cases cryptographic authentication may not be practical.

It would be desirable to provide a way to protect networks against attacks that use forged messages that is relatively simple and does not require the use of cryptographic authentication techniques.

### SUMMARY OF THE INVENTION

The invention provides methods, apparatuses and computer programs for use in a network for determining whether a forged message has been detected and for sending out a forgery declaration over the network when a forged message has been detected.

In accordance with one embodiment, the apparatus comprises an input/output (I/O) interface and a processor. The processor is configured to determine whether a communication received over the network via the I/O interface is a forged message, and causes a forgery declaration to be sent out over the network if it determines that the message is a forged message.

In accordance with another embodiment, the apparatus comprises an I/O interface and a processor. The processor is configured to determine whether a communication received over the network via the I/O interface comprises a forgery declaration indicating that a forged message has been transmitted over the network.

In accordance with one embodiment, the method comprises receiving a message sent over the network, determining whether the message is a forged message, and, if a determination is made that the message is a forged message, causing a forgery declaration to be sent over the network.

In accordance with another embodiment, the method comprises receiving a message sent over the network, determining whether the received message comprises a forgery declaration declaring that a forged message has been detected on the network, and, if a forgery has been detected, taking some action to protect the network.

In accordance with one embodiment, a computer program comprises instructions for receiving a message sent over the network, instructions for determining whether the message is a forged message, and instructions for causing a forgery declaration to be sent over the network if a determination is made that the message is a forged message.

In accordance with another embodiment, the computer program comprises instructions for receiving a message sent over the network, and instructions for determining whether the received message comprises a forgery declaration declaring that a forged message has been detected on the network.

These and other features and advantages of the invention will become apparent from the following description, drawings and claims.

### BRIEF DESCRIPTION OF THE DRAWINGS

FIG. 1 illustrates a network diagram that demonstrates an example of the manner in which the invention protects against impersonation attacks.

FIG. 2 illustrates a flowchart that represents an algorithm for determining whether a forgery has been detected.

FIG. 3 illustrates a flowchart that represents an algorithm for determining whether a forgery declaration has been received.

FIG. 4 illustrates a block diagram of the apparatus of the invention in accordance with an exemplary embodiment.

FIG. 5 illustrates a state diagram that represents the states of a finite state machine of the detector node shown in FIG. 1.

FIG. 6 illustrates a state diagram that represents the states of a finite state machine of one of the non-detector nodes shown in FIG. 1.

FIG. 7 illustrates a state diagram that represents the states of a finite state machine 90 of the forwarder node shown in FIG. 1.

### DETAILED DESCRIPTION OF EXEMPLARY EMBODIMENTS

The present invention provides a method and an apparatus for protecting against forged messages, or impersonation attacks. The invention does not require the use cryptography. In accordance with the invention, one or more nodes on the network are configured to detect a forged message and to output an indication that a forged message has been detected. Nodes that receive an indication that a forged message has been detected may then take certain actions, such as, for example, discontinuing use of the protocol associated with the forged message for a period of time.

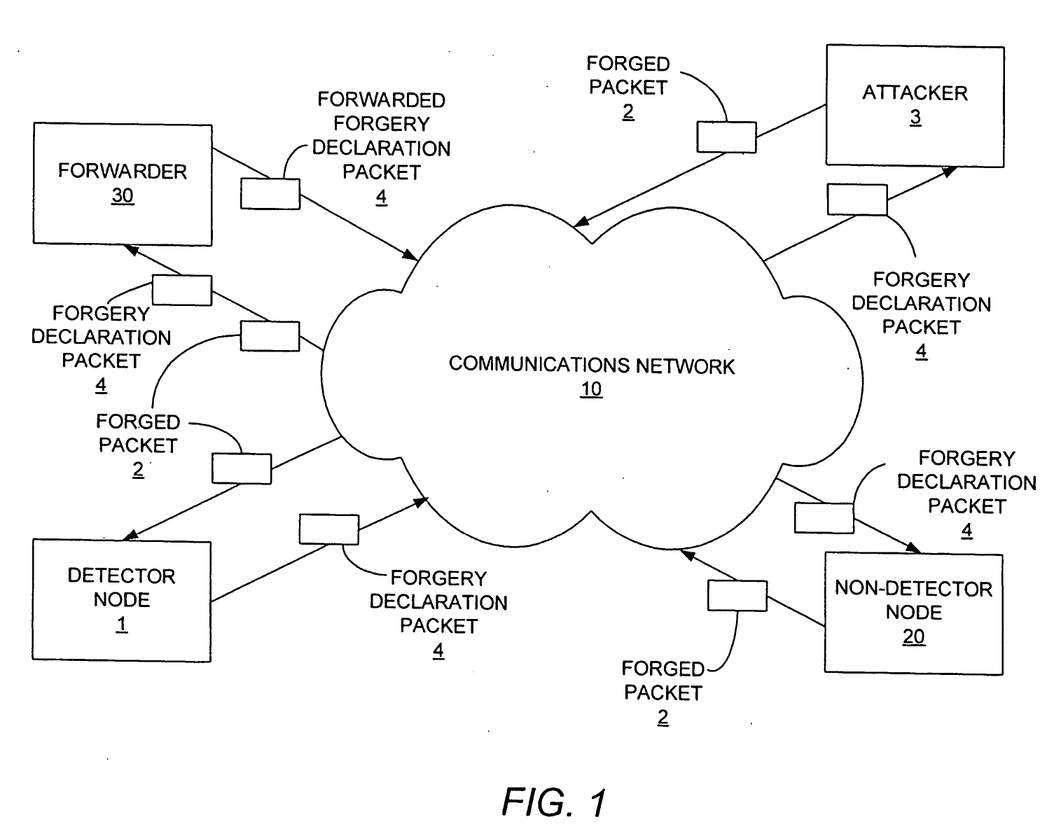

FIG. 1 illustrates a network diagram that demonstrates an example of the manner in which the invention protects against impersonation attacks. One or more detector nodes 1 on the network 10 are configured to directly detect forged packets 2 transmitted by one or more “attackers” nodes 3, and to output an indication 4 that a forged packet has been detected. The indication 4 is referred to herein as a “forgery declaration packet”. However, any type of communication message may be used to provide the indication that a forgery has been detected.

One or more non-detector nodes 20 on the network 10 do not directly detect forged packets. It is not necessary that the network 10 include non-detector nodes 20. The purpose for including non-detector nodes 20 in the network 10 is to demonstrate that it is not necessary for every node to have the ability to detect forged packets. Also, while the network 10 is being described as a packet-based network, the network 10 may be any type of network (e.g., circuit-switched) in which it is possible to have forged-message attacks. The network 10 may be a wired network or a wireless network, or a combined wireless and wired network.

It should be noted that the status of a node (e.g., detector, non-detector, forwarder, etc.) is not fixed. For example, some nodes can detect forgeries of one protocol (e.g., protocol P), but cannot detect forgeries of another protocol (e.g., P′ forgeries). Similarly, even if a node can detect some P forgeries, this does not mean it can detect all P forgeries. For example, if an attacker is pretending to be a specific node, node N, often only node N can detect the forgery. Therefore, a node's status as detector and non-detector can change on a per-packet basis. Also, a node can assume multiple identities. For example, a non-detector node of P forgeries can forward a P forgery declaration.

While an authentic forgery declaration offers explicit evidence that at least one detector node thinks an attacker is present, forgery declarations themselves may be forged. The extent to which a forgery declaration should be authenticatable hinges in part on the strength of the security scheme protecting the protocol, P, against which attacks can be mounted. If the attackable protocol P is not strongly protected (e.g., does not use cryptologic security mechanisms), then forgery declarations about P do not necessarily need to be strongly protected because if an entity has successfully forged a forgery declaration about P that is not strongly protected, then it is not unreasonable to conclude that the same entity can or already has successfully attacked the not-strongly protected protocol P. The same logic holds if both protocol P and forgery declarations about protocol P are strongly protected (e.g., cryptologically). However, if the attackable protocol P is strongly protected (e.g., cryptologically), but forgery declarations about protocol P are not strongly protected, then it may be unreasonable to assume that the entity that can forge forgery declarations about protocol P can also forge protocol P, since the latter is much more difficult than the former.

With reference again to FIG. 1, one or more forwarder nodes 30 on the network 10 do not detect forged packets, but are configured to forward an indication that a forgery has been detected to other nodes on the network. The forwarder node 30 is useful in cases in which every node on the network does not receive every communication sent over the network. In these cases, a forwarder node 30 may be used to communicate the indication of the detected forgery to nodes on the network that would not otherwise receive the forgery declaration. It is not necessary that the network 10 include a forwarder node 30. For example, in Ethernet networks all nodes are capable of receiving all communications sent over the network, in which case it would not be necessary to include a forwarder node because every node will receive the forgery declaration packet.

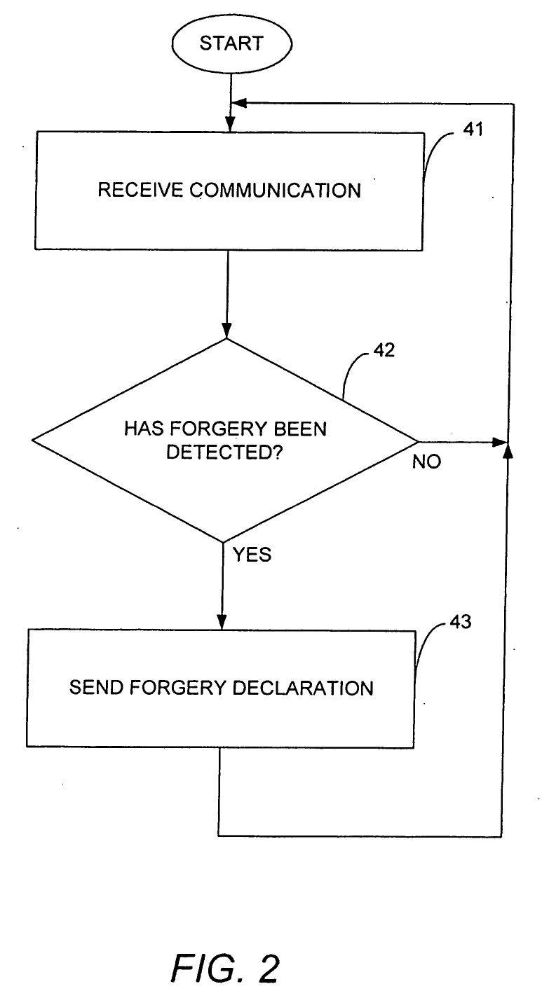

FIG. 2 illustrates a flowchart that represents the algorithm for determining whether a forgery has been detected. A variety of techniques can be used to determine whether a forgery has been detected. For example, if the source address of the received message matches the source address of the receiving node, the receiving node will determine that the message has been forged. In some networks, a node communicates only with a set of other nodes, and does not communicate with nodes outside of the set. In this case, if a receiving node determines that the received message was sent by a node that is not a member of the set, then the receiving node will determine that a forgery has been detected. In some networks, a node may be the sole allocator of addresses for devices on the network. In this case, if the allocator node receives a message having a source address that was not allocated by the allocator node, it will determine that a forgery has been detected.

As shown in FIG. 2, the communication (e.g., incoming packet) is received by the receiving node, as indicated by block 41. A determination is then made as to whether a forgery has been detected, as indicated by block 42. If so, a forgery declaration is sent out over the network, typically by the node that detected the forgery, as indicated by block 43.

Although the example depicted in FIG. 2 describes the tasks of detecting a forgery and sending out a forgery declaration as being performed by the receiving node, these tasks could be performed by separate nodes. For example, the node that receives the communication can make the determination as to whether it is a forgery. That node might then forward an indication that a forgery has been detected to a second node, which would then send out a forgery declaration. In addition, the forwarded indication that a forgery has been detected does not need to be encrypted because if it is a forgery, it will be detected.

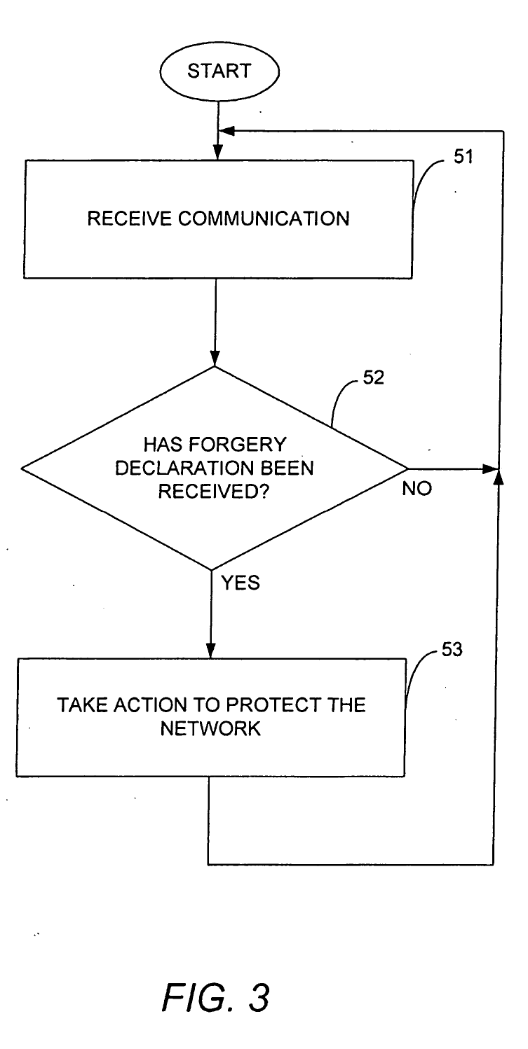

FIG. 3 illustrates a flowchart that represents the algorithm for protecting the network when a determination is made that a forgery declaration has been received by a node on the network. The communication is received by the receiving node, as indicated by block 51. A determination is then made as to whether the communication comprises a forgery declaration, as indicated by block 52. If so, some action is taken to protect the network, as indicated by block 53. The invention is not limited to taking any particular action to protect the network. A variety of actions may be taken to protect the network. As stated above, one action that may be taken is discontinuing use of the protocol associated with the forged message for a period of time.

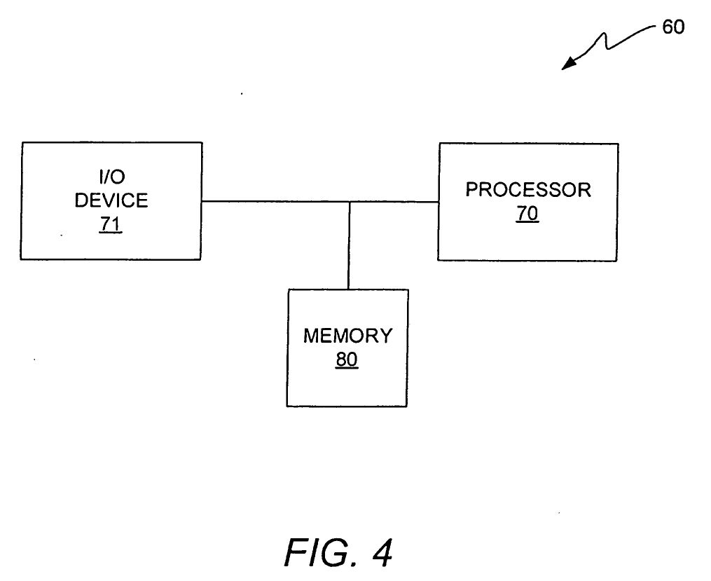

FIG. 4 illustrates a block diagram of the apparatus 60 of the invention in accordance with an exemplary embodiment. The apparatus 60 may be located at any or all of the nodes 1, 20 and 30 shown in FIG. 1. The apparatus 60 comprises a processor 70 for performing one or more of the algorithms described above, and an input/output (I/O) port 71. The apparatus 60 typically also comprises a memory device 80 for storing data and computer instructions associated with the algorithms that are performed by the apparatus 60.

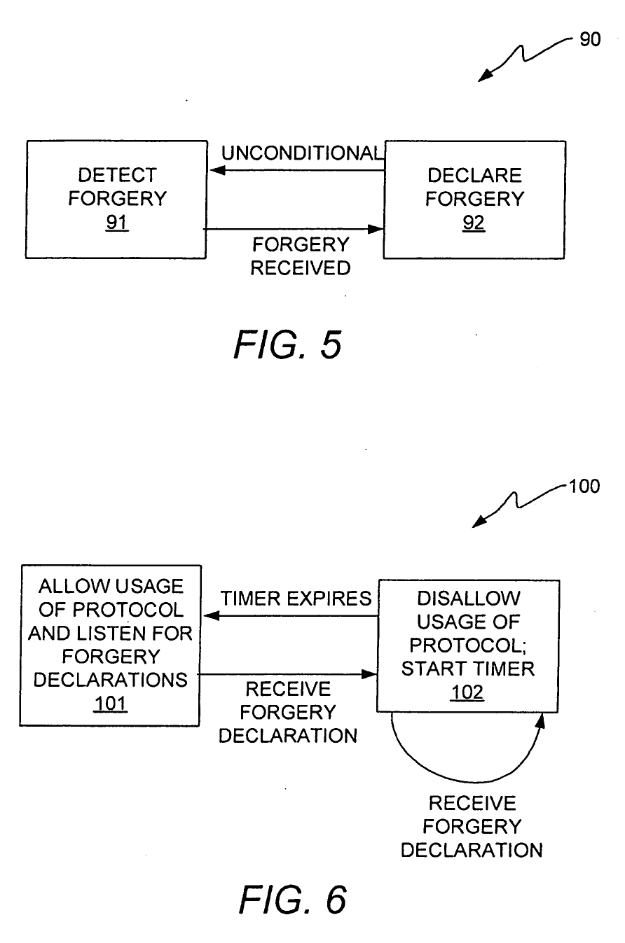

FIG. 5 illustrates a state diagram that represents the states of a finite state machine of the detector node 1 shown in FIG. 1. The state machine 90 performs an algorithm for detecting forged packets, as indicated by state 91. When a forged packet is detected, the state machine enters state 92. In state 92, the forgery is declared and the forgery declaration is sent out. The state machine 90 then re-enters state 91.

FIG. 6 illustrates a state diagram that represents the states of a finite state machine of one of the non-detector nodes 20 shown in FIG. 1. The state machine 100 performs an algorithm that listens for forgery declarations as it performs a particular protocol, as indicated by state 101. When a forgery declaration is received, the state machine enters state 102. In state 102, the protocol ceases to be used and a timer is started. While in this state, receiving a forgery declaration will not cause the state machine to enter a different state. When the timer expires, the state machine 100 then re-enters state 101.

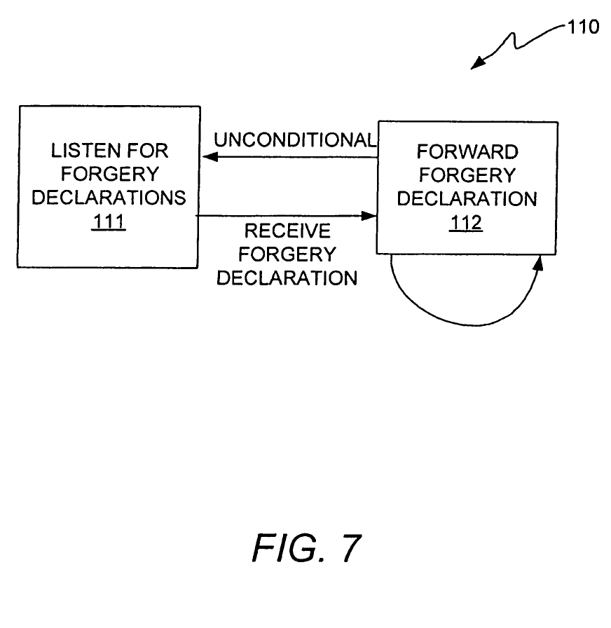

FIG. 7 illustrates a state diagram that represents the states of a finite state machine 110 of the forwarder node 30 shown in FIG. 1. The state machine 110 performs an algorithm for that listens for forgery declarations, as indicated by state 111. When a forgery declaration is received, the state machine enters state 112. In state 112, the forgery declarations is forwarded to non-detector nodes. The state machine 110 then re-enters state 111.

It should be noted that the inventions is not limited to the algorithms represented by the flowcharts shown in FIGS. 2 and 3. These algorithms represent the performance of certain exemplary tasks in order to achieve the goals of the invention. Likewise, the state diagrams shown in FIGS. 5-7 demonstrate examples of the manner in which nodes can behave in accordance with the invention. The invention is not limited with respect to the various tasks that may be performed by network nodes to achieve the goals of the invention.

The algorithms described above with reference to FIGS. 2, 3 and 5-7 may be achieved by hardware, software, or firmware, or by a combination of hardware, software and/or firmware. When performed in software and/or firmware, the algorithms typically are implemented by computer instructions. The computer instructions are typically stored in computer-readable memory devices located at the nodes such as, for example, a random access memory (RAM) device, a dynamic RAM (DRAM) memory device, a flash memory device, a read only memory (ROM) device, a compact disk ROM (CD-ROM) device, digital video disks (DVDs), magnetic disks, magnetic tapes, etc. The computer instructions may also be contained in electrical signals modulated on wired and wireless carriers (e.g., electrical conductors, wireless carrier waves, etc.) in packets and in non-packet formats.

The algorithms described above with reference to FIGS. 2, 3 and 5-7 are performed by respective processors located at the respective nodes. A processor, as that term is used herein, is intended to denote any type of computational device capable of performing the tasks described above, including, for example, a microprocessor, a microcontroller, an application specific integrated circuit (ASIC), a programmable gate array, a programmable logic array, etc. The processors communicate over the network via input/output interfaces of the nodes. The processors communicate with respective memory devices in which the aforementioned computer instructions are stored.

Although the invention may use encryption, the invention does not require the use of encryption. In accordance with one exemplary embodiment, the invention is implemented as a “Non-authenticated Forgery Declaration Protocol” (NAFDP), which is used to protect other protocols against impersonation attacks. The NAFDP formally defines the functionality of detector nodes, non-detector nodes, forwarder nodes, and the format of forgery declaration messages. An NAFDP forgery declaration message provides at least information indicating that a forgery has been detected. The message typically also includes information as to what protocol has been attacked, and may include information as to which specific message(s) have been forged, the address of the node that issued the forged message, and hints as to how non-detector nodes might react upon receipt of the declaration.

In accordance with a second exemplary embodiment, the present invention is incorporated directly into a vulnerable protocol regardless of whether that protocol uses cryptographic techniques for security. For instance, a vulnerable protocol may be supplemented with a purpose-defined “forger declaration” message or supplemented with a “forger detected” field inside of messages that have previously been defined. Alternatively, a vulnerable protocol may be supplemented in a manner that allows detector nodes to declare implicitly that they have directly detected a forgery without using a new message or new field. The latter technique may be useful, for example, in cases in which non-detector nodes treat duplicated messages as an implicit forgery declaration and detector nodes replay forged packets, thereby causing non-detector nodes to receive one or more duplicates.

In accordance with a third exemplary embodiment, the present invention is used in an “Authenticated Forgery Declaration Protocol” (AFDP), which is used to protect other protocols against impersonation attacks. The AFDP is similar to the NAFDP except that AFDP messages are authenticated, i.e., encryption is used. Thus, the invention may be used along with encryption techniques, but it is not necessary for the invention to be used with encryption techniques.

The invention is not limited to being implemented at any particular location of the network or in any particular device or component of the network. The detector node is typically a firewall device, but may be other devices as well.

The invention has been described with reference to exemplary embodiments. The invention, however, is not limited to the embodiments described herein. It will be understood by those skilled in the art in view of the description provided above that modifications may be made to the embodiments described above and that all such modifications are within the scope of the invention.

What is claimed is:

1. An apparatus for protecting a network against a forged message attack, the apparatus comprising:
an input/output (I/O) interface electrically coupled to the network; and
a processor electrically coupled to the I/O interface, the processor being configured to determine whether a communication received over the network via the I/O interface is a forged message, wherein if the processor determines that the message is a forged message, the processor causes a forgery declaration to be sent out over the network.

2. The apparatus of claim 1, wherein the processor makes the determination of whether a message is a forged message by determining whether a source address associated with the received message matches a source address associated with the apparatus.

3. The apparatus of claim 1, wherein the processor makes the determination of whether a message is a forged message by determining whether a source address associated with the received message matches a source address associated with a member of a set of nodes on the network.

4. The apparatus of claim 1, wherein the processor makes the determination of whether a message is a forged message by determining whether a source address associated with the received message matches a source address previously allocated by the node.

5. An apparatus for protecting a network against a forged message attack, the apparatus comprising:
an input/output (I/O) interface electrically coupled to the network; and
a processor electrically coupled to the I/O interface, the processor being configured to determine whether a communication received over the network via the I/O interface comprises a forgery declaration indicating that a forged message has been transmitted over the network.

6. The apparatus of claim 5, wherein if the processor determines that a forgery declaration has been received, the apparatus discontinues use of a protocol associated with the forged message.

7. The apparatus of claim 5, wherein if the processor determines that a forgery declaration has been received, the apparatus starts a timer and discontinues use of a protocol associated with the forged message until the timer times out.

8. The apparatus of claim 5, wherein if the processor determines that a forgery declaration has been received, the apparatus causes the forgery declaration to be forwarded to one or more other nodes on the network.

9. A method for protecting a network against a forged message attack, the method comprising:
receiving a message sent over the network;
determining whether the message is a forged message;
if a determination is made that the message is a forged message, causing a forgery declaration to be sent over the network.

10. The method of claim 9, wherein the determination of whether a message is a forged message is made by determining whether a source address associated with the received message matches a source address associated with the apparatus.

11. The method of claim 9, wherein the determination of whether a message is a forged message is made by determining whether a source address associated with the received message matches a source address associated with a member of a set of nodes on the network.

12. The method of claim 9, wherein the determination of whether a message is a forged message is made by determining whether a source address associated with the received message matches a source address previously allocated by the node.

13. A method for protecting a network against a forged message attack, the method comprising:
receiving a message sent over the network;
determining whether the received message comprises a forgery declaration declaring that a forged message has been detected on the network; and
if a forgery has been detected, taking one or more actions to protect the network.

14. The method of claim 13, wherein the action that is taken is discontinuing use of a protocol associated with the forged message.

15. The method of claim 13, wherein the actions that are taken are causing a timer to be started and discontinuing use of a protocol associated with the forged message until the timer times out.

16. The method of claim 13, wherein the action that is taken is causing the forgery declaration to be forwarded to one or more other nodes on the network.

17. A computer program for protecting a network against a forged message attack, the computer program comprising instructions for execution by a computer and being embodied on a computer-readable medium, the program comprising:
instructions for receiving a message sent over the network;
instructions for determining whether the message is a forged message;
instructions for causing a forgery declaration to be sent over the network if a determination is made that the message is a forged message.

18. The computer program of claim 17, wherein the instructions that determine whether a message is a forged message include instructions for determining whether a source address associated with the received message matches a source address associated with the apparatus.

19. The computer program of claim 17, wherein the instructions that determine whether a message is a forged message include instructions for determining whether a source address associated with the received message matches a source address associated with a member of a set of nodes on the network.

20. The computer program of claim 17, wherein the instructions that determine whether a message is a forged message include instructions for determining whether a source address associated with the received message matches a source address previously allocated by the node.

21. A computer program for protecting a network against a forged message attack, the computer program comprising instructions for execution by a computer and being embodied on a computer-readable medium, the program comprising:
instructions for receiving a message sent over the network; and
instructions for determining whether the received message comprises a forgery declaration declaring that a forged message has been detected on the network.

22. The computer program of claim 21, further comprising:
instructions for discontinuing use of a protocol associated with the forged message if a determination is made that the received message is a forgery declaration.

23. The computer program of claim 21, further comprising:
instructions for causing a timer to be started and discontinuing use of a protocol associated with a forgery declaration until the timer times out.

24. The computer program of claim 21, further comprising:
instructions for causing the forgery declaration to be forwarded to one or more other nodes on the network.
